(19) United States
(12) Patent Application Publication
(10) Pub. No.: US 2010/0161222 A1
(43) Pub. Date: Jun. 24, 2010

(54) NAVIGATION SYSTEM AND METHOD INTEGRATING WEATHER INFORMATION

(75) Inventor: Yinhe Zhang, Shanghai (CN)

Correspondence Address: Wang Law Firm, Inc., 4989 Peachtree Parkway,, Suite 200, Norcross, GA, 30092, US

(73) Assignees: MITAC International Corp., Taoyuan (TW); MITAC Research (Shanghai) Ltd., Shanghai (CN)

(21) Appl. No.: 12/488,542

(22) Filed: Jun. 20, 2009

(30) Foreign Application Priority Data
Dec. 23, 2008 (TW) 097150307

(51) Int. Cl. G01C 21/36

(52) U.S. Cl. 701/210; 701/209

(57) ABSTRACT

A navigation system integrating weather information is disclosed, which includes a weather information module for storing regional weather information indicating different weather condition levels and a threshold value corresponding to one of the weather condition levels; an electronic map database for storing map information; a positioning module for receiving a positioning signal via a global positioning system; and a navigation module for planning out a driving route based on the map information and the regional weather information to avoid any region that has a weather condition level higher than the threshold value and providing a navigation message based on the planned driving route and the received positioning signal. A navigation method applicable to a navigation system integrating weather information is also provided.

### FIELD OF THE INVENTION

The present invention relates to a navigation system and method, and more particularly to a navigation system and method that integrates weather information while providing the navigation function.

### BACKGROUND OF THE INVENTION

With the gradually matured techniques and the constantly lowered manufacturing cost for global positioning system (GPS) navigation system, a GPS navigation product has become one of the prerequisite devices for every car driver. The GPS navigation device receives at least four GPS signals to compute the latitude and longitude of the GPS navigation device. By comparing the latitude and the longitude with an electronic map, it is able to obtain information about the location where the GPS navigation device is positioned. Then, the GPS navigation device executes route planning and navigation functions to assist a driver in approaching to a desired destination. In brief, with the GPS navigation device, a driver may avoid from the confusion of getting lost.

As a result of global warming, changes in Nature are frequent and unpredictable. Bad weather conditions, such as rainstorm, heavy snow, earthquake, typhoon, etc., all have influences on the forming of landslide and road collapse. However, none of the currently available GPS navigation devices considers the importance of regional weather information regarding the safety of driving through a region while planning a driving route for a driver. The driver just follows the driving route indicated by the conventional navigation device, and is not able to avoid the possibility of driving into an interrupted road section caused by heavy rain or other weather factors. In some worse conditions, the driver might be hit by a falling rock during driving. Therefore, it is important to develop a GPS navigation system that is capable of considering the safety of the user and the car while providing the navigation function.

### SUMMARY OF THE INVENTION

A primary object of the present invention is to provide a navigation system and method that integrates weather information while providing a navigation function, so as to eliminate traffic accidents caused by driving in a region for lack of taking regional weather condition into consideration.

To achieve the above and other objects, the navigation system integrating weather information according to a preferred embodiment of the present invention includes a weather information module for storing regional weather information indicating different weather condition levels and a threshold value corresponding to one of the weather condition levels; an electronic map database for storing map information; a positioning module for receiving a positioning signal via a global positioning system; and a navigation module for planning out a driving route based on the map information and the regional weather information to avoid any region that has a weather condition level higher than the threshold value, and providing a navigation message based on the planned driving route and the received positioning signal.

The weather information module further includes a classification module for classifying the regional weather information according to different weather types, and each of the classified types of regional weather information is specified with a specific threshold value; and a warning module for determining whether a warning message is included in the regional weather information, and prompting a driver to plan out a new driving route if the warning message is included in the regional weather information.

In another embodiment of the navigation system integrating weather information according to the present invention, a receiving module may further be utilized for receiving real-time regional weather information indicating different weather condition levels to update the regional weather information previously stored in the weather information module. The receiving module comprises an inquiry module for transmitting an inquiry signal to a weather center for inquiring the real-time regional weather information indicating different weather condition levels.

And, the navigation method integrating weather information according to the present invention includes the following steps: providing regional weather information indicating different weather condition levels and specifying a threshold value corresponding to one of the weather condition levels; acquiring a positioning signal; providing map information; and planning out a driving route based on the map information and the regional weather information to avoid any region that has a weather condition level higher than the threshold value, and providing a navigation message based on the planned driving route and the acquired positioning signal.

In consideration of the unpredictable quick changes in weather, such as the unexpected sudden earthquake, landslide, heavy fog, etc., another embodiment of the navigation method integrating weather information according to the present invention includes the following steps: receiving regional weather information having a warning message; acquiring a positioning signal; providing map information; and planning out a driving route based on the map information and the regional weather information to avoid any region that has been issued the warning message, and providing a navigation message based on the planned driving route and the acquired positioning signal.

According to the above description, the navigation system and method integrating weather information according to the present invention has one or more of the following advantages: (1) providing the navigation function while protecting a driver and passengers against injury and a car against damage, and (2) capable of receiving or inquiring real-time regional weather information and updating the stored weather information to avoid passing through a region having extremely bad weather.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a navigation system integrating weather information according to a first embodiment of the present invention;

FIG. 2 is a block diagram of a navigation system integrating weather information according to a second embodiment of the present invention;

FIG. 3 is a flowchart showing the steps included in a first embodiment of a navigation method integrating weather information according to the present invention; and

FIG. 4 is a flowchart showing the steps included in a second embodiment of the navigation method integrating weather information according to the present invention.

### DETAILED DESCRIPTION OF THE PREFERRED EMBODIMENTS

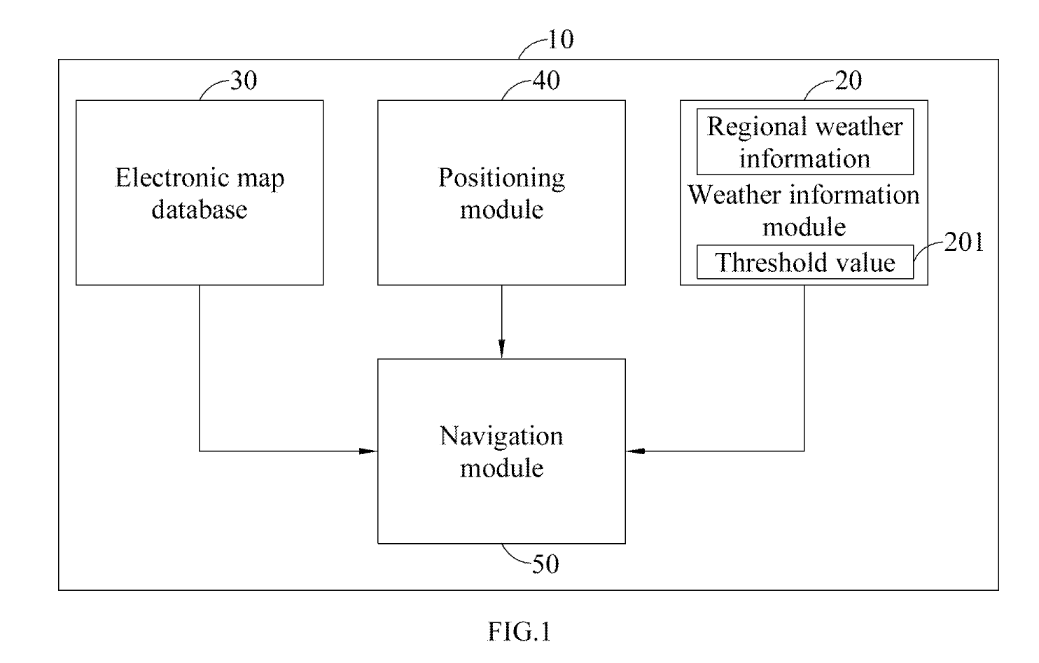

Please refer to FIG. 1 which is a block diagram of a navigation system integrating weather information 10 according to a first embodiment of the present invention. As shown, the navigation system 10 in the first embodiment comprises a weather information module 20, an electronic map database 30, a positioning module 40, and a navigation module 50.

The weather information module 20 stores regional weather information indicating different weather condition levels and a specified threshold value 201 corresponding to one of the weather condition levels. Table 1 listed below shows an example of the regional weather information indicating different weather condition levels:

TABLE 1
Rainfall Information

| Level | Regional Accumulated Rainfall |
|---|---|
| Extremely torrential rain | 350 mm and above |
| Torrential rain | 200 mm and above |
| Extremely heavy rain | 130 mm and above |
| Heavy rain | 50 mm and above |

And, for example, based on the above-listed different levels of rainfall, the level of extremely heavy rain may be set as the threshold value 201 for the navigation system 10.

The electronic map database 30 has information of a plurality of regional electronic maps stored therein.

The positioning module 40 receives a positioning signal via a global positioning system (GPS). The positioning signal indicates a current address of the navigation system 10. As soon as the navigation system 10 is turned on, the positioning module 40 may start receiving the current address of the navigation system 10, and uses the current address as a starting point of a driving route. When the navigation system 10 is moved to another position, the positioning module 40 is able to continuously receive the positioning signal for the navigation system 10 in real time, so as to derive a moving path of the navigation system 10.

When a user actuates the navigation system 10 and enters a desired destination, the navigation module 50 may use the information of the plurality of regional electronic maps in the electronic map database 30 and the regional weather information indicating different weather condition levels stored in the weather information module 20 to determine whether the weather condition level of a region on the way to the destination is higher than the preset threshold value 201, which represents an extremely heavy rain in the illustrated embodiment. If yes, the navigation module 50 will plan out a driving route that does not pass through that region, and provides a navigation message based on the planned driving route and the positioning signal provided by the positioning module 40. Or, if not, the navigation module 50 will plan out a driving route that will pass through that region, and provides a navigation message based on the planned driving route and the positioning signal provided by the positioning module 40.

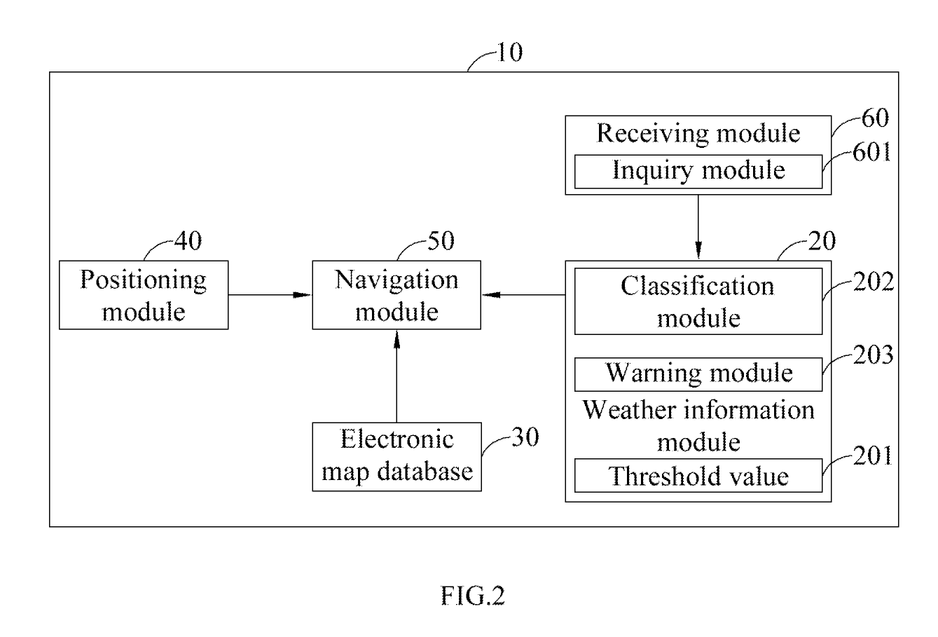

Please refer to FIG. 2 which is a block diagram of a navigation system integrating weather information 10 according to a second embodiment of the present invention. The navigation system 10 in the second embodiment is different from the first embodiment in that it includes a receiving module 60 having an inquiry module 601, and a weather information module 20 further having a classification module 202 and a warning module 203.

The receiving module 60 of the navigation system 10 is used to receive regional weather information indicating different weather condition levels and update in real time the regional weather information previously stored in the weather information module 20. The receiving module 60 may wirelessly receive the regional weather information indicating different weather condition levels by utilizing different communication techniques, including but not limited to General Packet Radio Service (GPRS), Short Message Service (SMS) of the Global System for Mobile Communications (GSM), and Multimedia Messaging Service (MMS).

The receiving module 60 further includes an inquiry module 601. With the inquiry module 601, the navigation system 10 may actively inquire required weather information. An inquiry signal may be transmitted via the inquiry module 601 to a location, such as a weather information center or a Weather Bureau, from where real-time regional weather information indicating different weather condition levels may be obtained, so as to achieve the purpose of actively inquiring necessary weather information. When the weather information center has weather information meeting the user's need, the weather information may be transmitted back to the receiving module 60. It is also possible for the inquiry module 601 to wirelessly transmit the inquiry signal.

The weather information module 20 in the second embodiment further includes a classification module 202. There are different types of regional weather information, such as heavy rain information, typhoon information, heavy snow information, etc. Different weather types have different influences on traffic. With the classification module 202, the navigation system 10 may classify the received regional weather information indicating different weather condition levels according to different weather types. For example, the received regional weather information may be classified into heavy rain information and typhoon information, as shown in the above Table 1 and the following Table 2, respectively.

TABLE 2
Typhoon Information

| Level | Regional Gust |
|---|---|
| Super Typhoon | Force 16 and above |
| Medium Typhoon | Force 12 to Force 15 |
| Mild Typhoon | Force 8 to Force 11 |

The user may set a specific threshold value for each of the different types of weather information as classified by the classification module 202. For example, the user may set the level of extremely heavy rain as a threshold value and the level of mild typhoon as another threshold value. Based on these threshold values, the navigation module 50 will plan out a driving route that does not pass any region having a weather condition level higher than the extremely heavy rain level and the mild typhoon level, and provides a navigation message based on the planned driving route and the positioning signal provided by the positioning module 40. With the classification module 202, the user may also preset the desired weather information types. For example, when driving in a tropical region, the user may classify the regional weather information into heavy rain information and typhoon information, so that the receiving module 60 only receives the heavy rain information and the typhoon information but not other regional weather information indicating heavy snow level.

The weather information module 20 in the second embodiment further includes a warning module 203. When the user activates the navigation system 10 during driving and uses the navigation messages provided by the navigation system 10, there are chances a region on the way to the destination has an unpredictable situation caused by sudden changes in regional weather condition, such as earthquake, landslide, heavy fog, etc. Under this condition, the warning module 203 is helpful in minimizing the influence of the sudden weather changes on the driving route. The warning module 203 is capable of determining whether there is a warning message in the regional weather information. If yes, the warning module 203 will prompt the user to plan a new driving route. When the prompt is accepted, the user may select to set the navigation system 10 to plan out a new driving route that does not pass through the region having been issued a warning message.

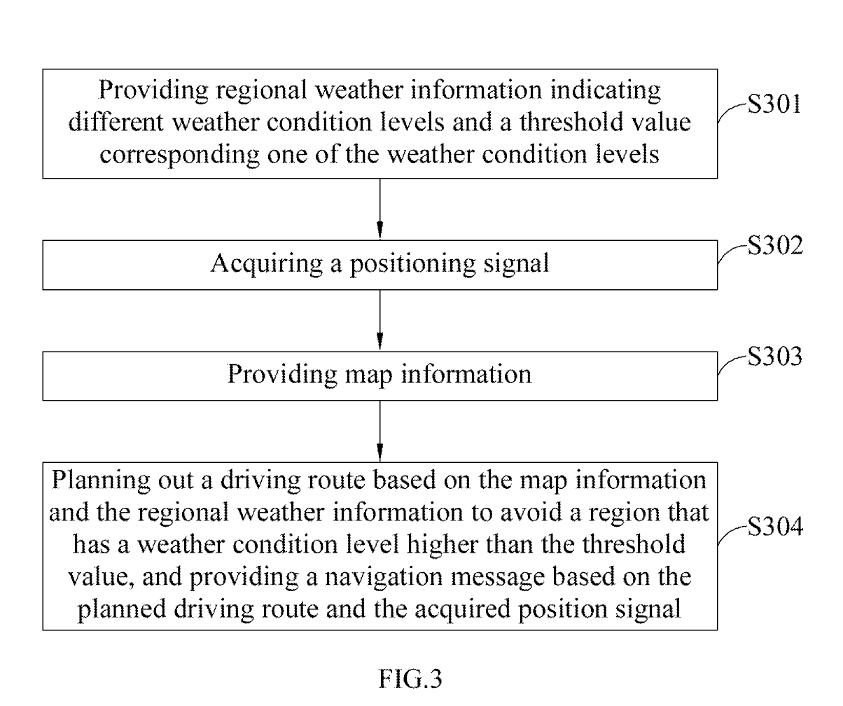

The present invention also provides a navigation method integrating weather information, which is applicable to a navigation system having a navigator integrating weather information. FIG. 3 is a flowchart showing the steps included in a first embodiment of the navigation method of the present invention.

In a first step S301, regional weather information indicating different weather condition levels is provided, and at least one threshold value corresponding to one of the weather condition levels included in the regional weather information is specified. There may be different types of regional weather information, such as heavy rain information, typhoon information, heavy snow information, etc. In the step S301, the regional weather information may be classified into different types according to different weather types, and a specific threshold values may be set for each of the classified types of regional weather information. Further, the regional weather information may be updated from time to time by wirelessly receiving the real-time regional weather information from a weather center, or by actively wirelessly inquiring the weather center for the real-time regional weather information.

In a second step S302, a positioning signal is acquired by receiving the positioning signal via a global positioning system (GPS).

In a third step S303, an electronic map database having information of a plurality of regional electronic maps stored therein is used to provide related map information.

In a fourth step S304, a driving route is planned out based on the map information and the regional weather information to avoid passing any region having a weather condition level higher than the specified threshold value, and a navigation message is provided based on the planned driving route and the acquired positioning signal.

According to the navigation method in the first embodiment, a user may enter a desired destination when the navigation system is activated. Then, as in the step S301, the user may specify one of the weather condition levels indicated in the regional weather information as a threshold value. For example, the user may preset the extremely heavy rain level as the threshold value. The navigation system may receive a positioning signal via the GPS, as in the step S302, and provide the map information as in the step S303. In the event a region on the way to the destination has a rainfall level higher than the preset threshold value, a driving route that does not pass that region will be planned out as in the step S304, and a navigation message is provided based on the planned driving route and acquired positioning signal. Or, in the event the navigation system determines a region that is to be passed to get to the destination has a rainfall level lower than the present threshold value, a driving route passing through that region will be planned out in the step S304, and a navigation message is provided based on the planned driving route and the acquired positioning signal.

In a second embodiment of the navigation method integrating weather information according to the present invention, some unpredictable events possibly caused by quick changes in weather conditions, such as unexpected earthquake, landslide, heavy fog, etc., are taken into consideration. Since it is impossible to get from the weather center any forecast information about such unexpected changes in weather conditions, these changes in weather conditions are highly dangerous to drivers. With the second navigation method of the present invention, whenever a sudden change in weather conditions occurs and the weather center emergently issues weather information with a warning message, a navigation system applying the navigation method of the present invention may plan out a new driving route based on the emergent weather information and the warning message.

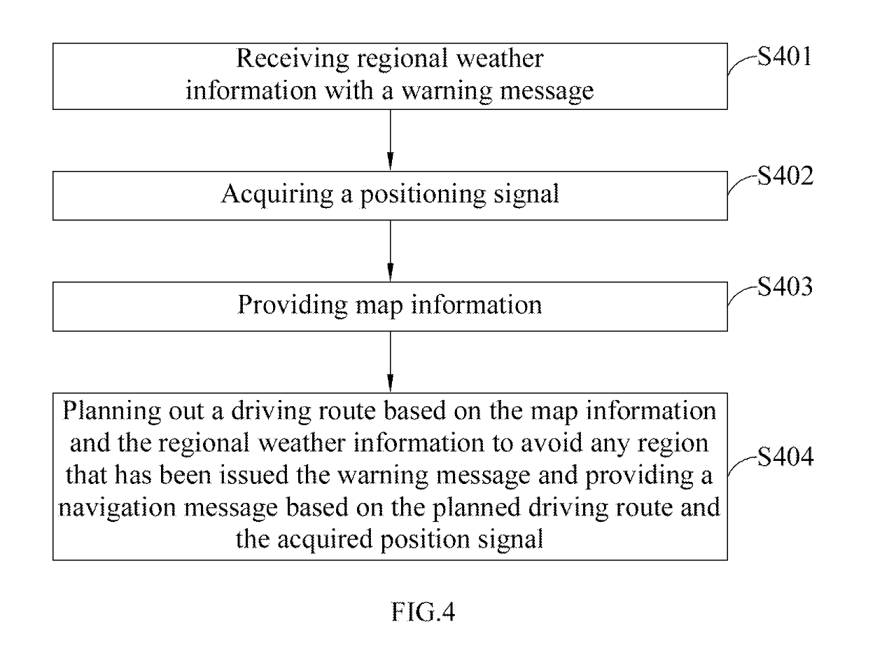

FIG. 4 is a flowchart showing the steps included in the second embodiment of the navigation method according to the present invention.

In a first step S401, regional weather information with a warning message is received. The regional weather information with a warning message may be wirelessly received and may include earthquake warning information, landslide warning information, heavy fog warning information, etc.

In a second step S402, a positioning signal is acquired by receiving the positioning signal via a global positioning system (GPS).

In a third step S403, an electronic map database having information of a plurality of regional electronic maps stored therein is used to provide related map information.

In a fourth step S404, a driving route is planned out based on the map information and the regional weather information to avoid passing any region having been issued a warning message, and a navigation message is provided based on the planned driving route and the acquired positioning signal.

In brief, the navigation system and method integrating weather information according to the present invention is advantageous in that the navigation system 10 is able to plan out a driving route based on the map information and the regional weather information to avoid any region that has a weather condition level higher than the preset threshold value or has been issued a warning message, and provides a navigation message based on the planned driving route and the received positioning signal. Therefore, with the navigation system 10 of the present invention, regional weather information may be received or checked and updated in real time to avoid a user from passing through a region having extremely bad weather condition. Thus, the driver and passengers are protected against injury and the car is protected against damage caused by bad weather condition during driving.

What is claimed is:

1. A navigation system integrating weather information, comprising:
a weather information module for storing regional weather information indicating different weather condition levels and a threshold value corresponding to one of the weather condition levels;
an electronic map database having map information stored therein;
a positioning module for receiving a positioning signal via a global positioning system (GPS); and
a navigation module for planning out a driving route based on the map information and the regional weather information to avoid any region that has a weather condition level higher than the threshold value, and providing a navigation message based on the planned driving route and the received positioning signal.

2. The navigation system integrating weather information as claimed in claim 1, wherein the regional weather information includes at least one of heavy rain information, typhoon information, and heavy snow information.

3. The navigation system integrating weather information as claimed in claim 1, wherein the weather information module further includes a classification module for classifying the regional weather information based on different weather types, and each of the classified types of regional weather information has a specific threshold value.

4. The navigation system integrating weather information as claimed in claim 1, further comprising a receiving module for receiving real-time regional weather information to update the regional weather information previously stored in the weather information module.

5. The navigation system integrating weather information as claimed in claim 4, wherein the receiving module further includes an inquiry module for transmitting an inquiry signal to a weather center for inquiring the real-time regional weather information.

6. The navigation system integrating weather information as claimed in claim 1, wherein the weather information module further comprises a warning module for determining whether a warning message in included in the regional weather information, and prompting a user to plan out another driving route if there the warning message is included in the regional weather information.

7. The navigation system integrating weather information as claimed in claim 6, wherein the navigation module further integrates the regional weather information having the warning message in planning out a new driving route and provides a new navigation message.

8. A navigation method integrating weather information comprising the following steps:
providing regional weather information indicating different weather condition levels and specifying a threshold value corresponding to one of the weather condition levels;
acquiring a positioning signal;
providing map information; and
planning out a driving route based on the map information and the regional weather information to avoid any region that has a weather condition level higher than the threshold value, and providing a navigation message based on the planned driving route and the acquired positioning signal.

9. The navigation method integrating weather information as claimed in claim 8., wherein the regional weather information includes at least one of heavy rain information, typhoon information, and heavy snow information.

10. The navigation method integrating weather information as claimed in claim 8 further comprising the following step:
classifying the regional weather information according to different weather types, and specifying a specific threshold value to each of the classified types of the regional weather information.

11. The navigation method integrating weather information as claimed in claim 8, further comprising the following step:
receiving real-time regional weather information from a weather center to update the previously provided regional weather information from time to time.

12. The navigation method integrating weather information as claimed in claim 8, further comprising the following step:
transmitting an inquiry signal to a weather center for inquiring real-time regional weather information.

13. A navigation method integrating weather information, comprising the following step:
receiving regional weather information with a warning message:
acquiring a positioning signal;
providing map information; and
planning out a driving route based on the map information and the regional weather information to avoid any region that has been issued the warning message, and providing a navigation message based on the planned driving route and the acquired positioning signal.

14. The navigation method integrating weather information as claimed in claim 13, wherein the regional weather information with a warning message includes at least one of earthquake information, landslide information, and heavy fog information.
